(19) United States
(12) Patent Application Publication
(10) Pub. No.: US 2026/0342449 A1
(43) Pub. Date: Oct. 29, 2026

(54) OPTICAL TRANSMISSION SYSTEM AND EQUALIZATION METHOD

(71) Applicant: NTT, Inc., Tokyo (JP)

(72) Inventors: Minami TAKAHASHI, Musashino-shi (JP); Masanori NAKAMURA, Musashino-shi (JP); Takeo SASAI, Musashino-shi (JP); Yoshiaki KISAKA, Musashino-shi (JP)

(73) Assignee: NTT, Inc., Tokyo (JP)

(21) Appl. No.: 18/998,964

(22) PCT Filed: Aug. 2, 2022
(86) PCT No.: PCT/JP2022/029645

§ 371 Date: Jan. 27, 2025

(51) Int. Cl. H04B 10/61; H04B 10/50

(52) U.S. Cl. CPC H04B 10/616; H04B 10/50

(57) ABSTRACT

An optical transmission system including: an optical transmitter that transmits an optical signal; an equalization unit that equalizes the optical signal transmitted from the optical transmitter in an optical domain; an optical receiver that receives the optical signal equalized by the equalization unit and acquires quality information regarding quality of the received optical signal; and a filter generation unit that generates a filter to be used for equalization processing on the basis of spectrum information of the optical signal equalized by the equalization unit and the quality information and sets the filter in the equalization unit.

### TECHNICAL FIELD

The present invention relates to an optical transmission system and an equalization method.

### BACKGROUND ART

In a digital coherent optical transmission system, an increase in communication capacity by higher order modulation or higher baud rate has been studied. On the other hand, since a signal subjected to higher order modulation or higher baud rate is easily affected by waveform distortion and noise derived from a transceiver and a transmission path, signal quality is improved by digitally compensating for imperfections of a transmitter. Although digital equalization has high compensation accuracy, the error rate increases because a peak-to-average power ratio (PAPR) of the processed signal increases. Therefore, optical equalization (OEQ) has attracted attention as a technique for performing device compensation while suppressing increase in the PAPR (see, for example, Non Patent Literature 1).

### CITATION LIST

### Non Patent Literature

Non Patent Literature 1: M. Nakamura, T. Kobayashi, F. Hamaoka, and Y. Miyamoto, “High Information Rate of 128-GBaud 1.8-Tb/s and 64-GBaud 1.03-Tb/s Signal Generation and Detection Using Frequency-Domain 8×2 MIMO Equalization”, OFC 2022 Optica Publishing Group 2022,

### SUMMARY OF INVENTION

### Technical Problem

However, in OEQ, an increase in PAPR can be suppressed, but when the amount of equalization increases, a decrease in output power due to equalization increases. As described above, since there is a trade-off relationship between the equalization amount and the output power, the relationship between the equalization amount and the signal quality has been unclear. Therefore, since the filter shape used in the OEQ cannot be optimized so as to maximize the signal quality, there is a problem that sufficient compensation cannot be performed.

In view of the above circumstances, an object of the present invention is to provide a technique capable of improving the compensation accuracy as compared with the related art.

### Solution to Problem

One aspect of the present invention is an optical transmission system including: an optical transmitter that transmits an optical signal; an equalization unit that equalizes the optical signal transmitted from the optical transmitter in an optical domain; an optical receiver that receives the optical signal equalized by the equalization unit and acquires quality information regarding quality of the received optical signal; and a filter generation unit that generates a filter to be used for equalization processing on the basis of spectrum information of the optical signal equalized by the equalization unit and the quality information and sets the filter in the equalization unit.

One aspect of the present invention is an equalization method including: transmitting, by an optical transmitter, an optical signal; equalizing, by an equalization unit, the transmitted optical signal in an optical domain; receiving, by an optical receiver, the equalized optical signal and acquiring quality information regarding quality of the received optical signal; and generating, by a filter generation unit, a filter to be used for equalization processing on the basis of spectrum information of the equalized optical signal and the quality information and setting the filter in the equalization unit.

### Advantageous Effects of Invention

According to the present invention, it is possible to improve the compensation accuracy as compared with the related art.

### BRIEF DESCRIPTION OF DRAWINGS

FIG. 1 A diagram illustrating a configuration example of an optical transmission system in a first embodiment.

FIG. 2 A diagram illustrating a method of calculating a frequency width to be compensated in the first embodiment.

FIG. 3 A sequence diagram illustrating a flow of processing of the optical transmission system in the first embodiment.

FIG. 4 A sequence diagram illustrating a flow of processing of the optical transmission system according to the first embodiment.

FIG. 5 A diagram for describing an effect in the first embodiment.

FIG. 6 A diagram illustrating a configuration example of an optical transmission system according to a second embodiment.

FIG. 7 A diagram illustrating a configuration example of an optical transmission system according to a third embodiment.

FIG. 8 A sequence diagram illustrating a flow of processing of the optical transmission system in the third embodiment.

FIG. 9 A sequence diagram illustrating a flow of processing of the optical transmission system in the third embodiment.

### DESCRIPTION OF EMBODIMENTS

Hereinafter, embodiments of the present invention will be described with reference to drawings.

### First Embodiment

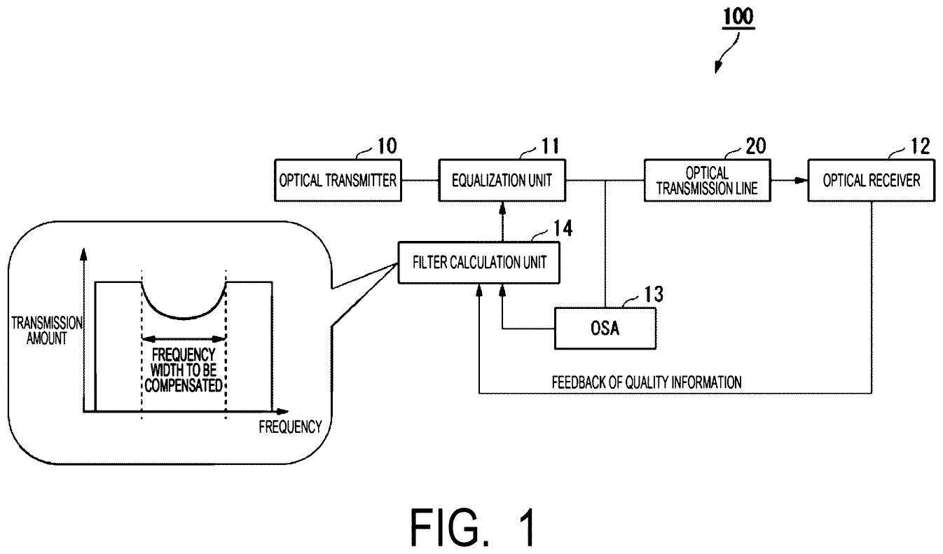

FIG. 1 is a diagram illustrating a configuration example of an optical transmission system 100 according to a first embodiment. The optical transmission system 100 includes an optical transmitter 10, an equalization unit 11, an optical receiver 12, an OSA 13, and a filter calculation unit 14. The optical transmitter 10 and the optical receiver 12 are connected via an optical transmission line 20. The equalization unit 11 and the filter calculation unit 14 are configured as equalizers.

The optical transmitter 10 transmits an optical signal. For example, the optical transmitter 10 transmits a polarization multiplexed signal. Note that the optical transmitter 10 may transmit an optical signal subjected to wavelength multiplexing or spatial multiplexing in addition to polarization multiplexing.

The equalization unit 11 is provided on the optical transmission line 20 between the optical transmitter 10 and the optical receiver 12. The equalization unit 11 equalizes the optical signal transmitted from the optical transmitter 10 in the optical domain. The equalization unit 11 performs compensation by OEQ, for example.

The optical receiver 12 receives the optical signal subjected to the equalization processing by the equalization unit 11. The optical receiver 12 acquires quality information of the received optical signal. The quality information of the optical signal is information related to signal quality of the optical signal, and is, for example, a bit error rate (BER), a Q value, a signal-to-noise ratio (SNR), a forward error correction (FEC) number, an adaptive equalizer (AEQ) error signal, or the like. During operation, the optical receiver 12 acquires quality information through a general communication channel (GCC), a digital signal processor (DSP) Com-ch, a control plane control channel, a network operation system (NW-OpS) control channel, and the like. Note that the setting may be made at the time of factory shipment. The optical receiver 12 feeds back the acquired quality information to the filter calculation unit 14.

The OSA 13 acquires the optical signal subjected to the equalization processing by the equalization unit 11, and acquires a signal spectrum of the acquired optical signal subjected to the equalization processing. The OSA 13 is an optical spectrum analyzer. The OSA 13 outputs the acquired signal spectrum information (hereinafter, the spectrum information is referred to as “spectrum information”) to the filter calculation unit 14. The OSA 13 is one aspect of a spectrum information acquisition unit.

The filter calculation unit 14 calculates a filter to be set in the equalization unit 11 on the basis of the quality information output from the optical receiver 12 and the spectrum information output from the OSA 13. The filter calculation unit 14 sets the calculated filter in the equalization unit 11. The filter calculation unit 14 may be configured as an equalization processing unit in combination with the equalization unit 11, or may be included in the optical receiver 12. The function of the filter calculation unit 14 may be realized by one or more processors.

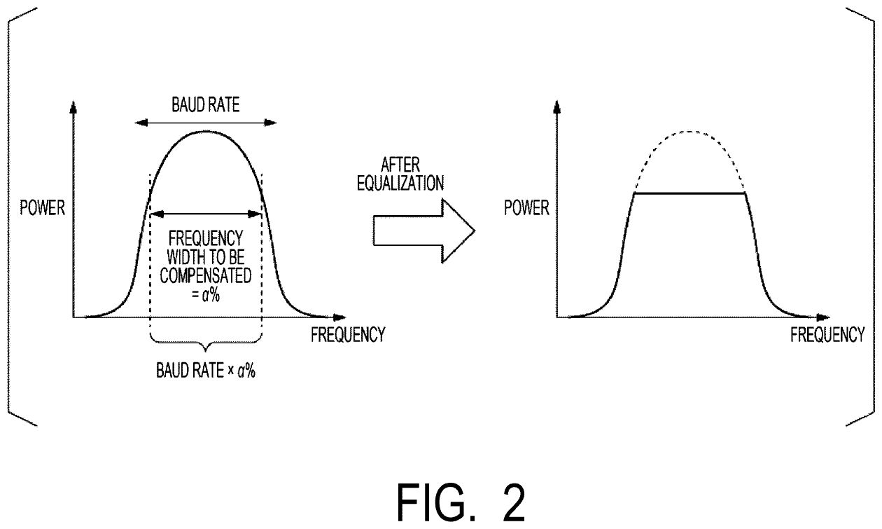

FIG. 2 is a diagram illustrating a method of calculating a frequency width to be compensated in the first embodiment. As illustrated in the left diagram of FIG. 2, the filter calculation unit 14 calculates the frequency width to be compensated on the basis of the ratio of the frequency band to the baud rate determined when setting the modulation scheme for the optical transmission system 100. The right diagram of FIG. 2 represents a signal spectrum compensated by a filter generated based on the calculated frequency width.

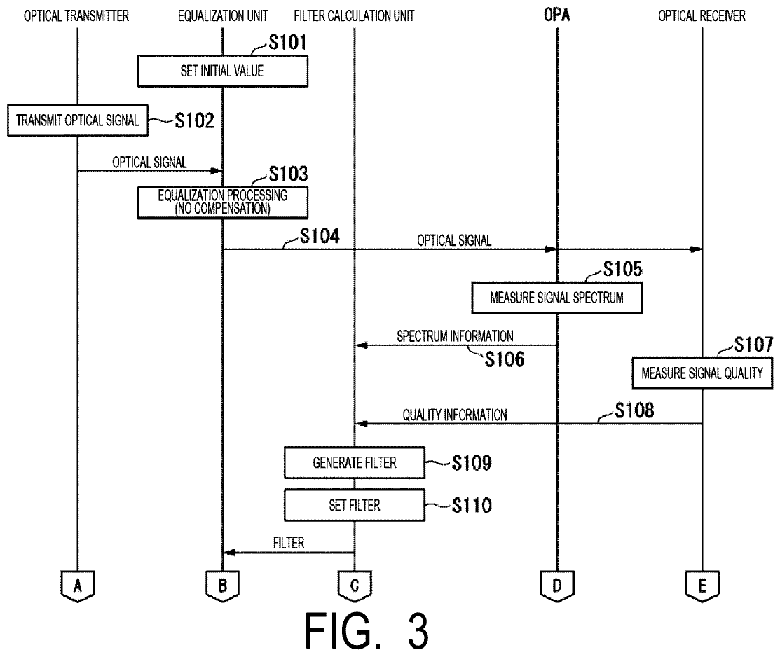

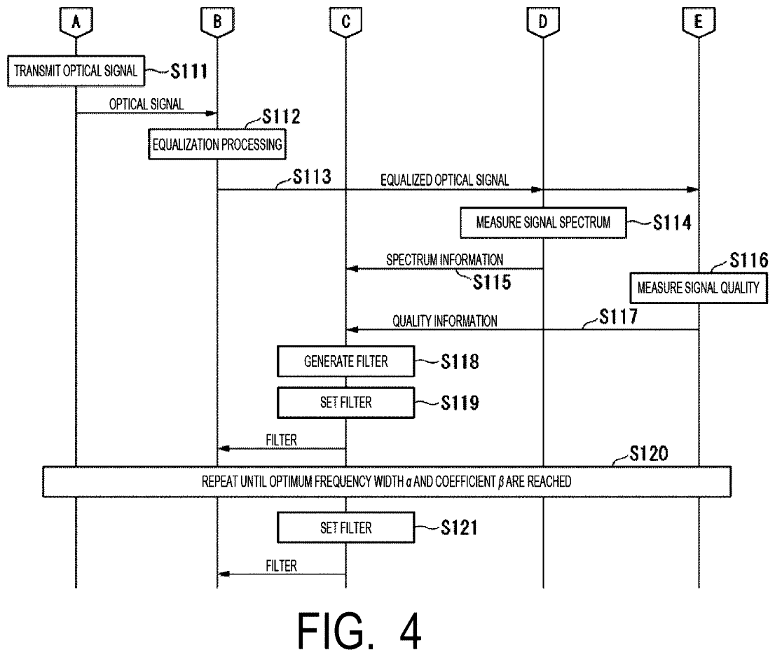

FIGS. 3 and 4 are sequence diagrams illustrating a flow of processing of the optical transmission system 100 in the first embodiment.

The equalization unit 11 sets an initial value at the start of processing (step S101). Here, as the initial value, no compensation by the filter (a frequency width α to be compensated=0%) is set in the equalization unit 11. Thereafter, the optical transmitter 10 transmits an optical signal (step S102). The optical signal transmitted by the optical transmitter 10 is input to the equalization unit 11 via the optical transmission line.

The equalization unit 11 performs equalization processing on the input optical signal (step S103). Since no compensation by the filter (a frequency width α to be compensated=0%) is set as the initial value, the optical signal input to the equalization unit 11 is output without being compensated (step S104). The optical signal output from the equalization unit 11 is branched in the optical transmission line 20. The branched optical signal is received by the optical receiver 12 and the OSA 13.

The OSA 13 measures a signal spectrum of the received optical signal (step S105). The OSA 13 outputs spectrum information obtained by the measurement to the filter calculation unit 14 (step S106). As a result, the spectrum information is input to the filter calculation unit 14. The optical receiver 12 measures the signal quality of the received optical signal (step S107). The optical receiver 12 outputs the information on the signal quality obtained by the measurement to the filter calculation unit 14 as quality information (step S108). As a result, the quality information is input to the filter calculation unit 14.

The filter calculation unit 14 generates a filter based on the input spectrum information and quality information (step S109). Specifically, the filter calculation unit 14 generates a filter using the inverse characteristic H^{-β}(f) (0≤β≤1) of the frequency width (for example, α=10%) to be compensated on the basis of the amplitude characteristic H(f) of the input signal spectrum. For example, when β=1, the signal spectrum after compensation approaches flat. The filter calculation unit 14 sets the generated filter in the equalization unit 11 (step S110). Note that the filter calculation unit 14 associates and holds the obtained quality information and the values of the frequency widths α to be compensated and β, which are parameters of the filter shape when the quality information is obtained.

Here, β represents a parameter for determining the degree of equalization within the set frequency width (α). As described above, when β is 1, the optical power distribution in the frequency width α approaches flat (see the right diagram of FIG. 2), and the equalization state is completely achieved. On the other hand, when β<1, the flat state of the optical power distribution within the frequency width α is relaxed. That is, when β<1, the equalization state is not complete. In the equalization by OEQ, since there is a power loss, β is defined as a parameter for relaxing the flat state such as β<1 and for providing a mechanism for finely adjusting the power loss.

The optical transmitter 10 transmits the optical signal again (step S111). The optical signal transmitted by the optical transmitter 10 is input to the equalization unit 11 via the optical transmission line. The equalization unit 11 performs equalization processing on the input optical signal (step S112). At this time, since a filter is set (a frequency width α to be compensated=10%) in the equalization unit 11, equalization processing is performed on the optical signal input to the equalization unit 11. As a result, the optical signal is compensated. The equalization unit 11 outputs the equalized optical signal to the optical transmission line 20 (step S113). The optical signal output from the equalization unit 11 is branched in the optical transmission line 20. The branched optical signal is received by the optical receiver 12 and the OSA 13.

The OSA 13 measures a signal spectrum of the received optical signal (step S114). The OSA 13 outputs spectrum information obtained by the measurement to the filter calculation unit 14 (step S115). As a result, the spectrum information is input to the filter calculation unit 14. The optical receiver 12 measures the signal quality of the received optical signal (step S116). The optical receiver 12 outputs the information on the signal quality obtained by the measurement to the filter calculation unit 14 as quality information (step S117). As a result, the quality information is input to the filter calculation unit 14.

The filter calculation unit 14 generates a filter based on the input spectrum information and quality information (step S118). Specifically, the filter calculation unit 14 generates a filter by increasing the frequency width α to be compensated and the coefficient β on the basis of the amplitude characteristic H(f) of the input signal spectrum. The filter calculation unit 14 sets the re-generated filter in the equalization unit 11 (step S119).

Thereafter, the processing from step S111 to step S119 is repeatedly executed until the optimum frequency width α and coefficient β are reached (step S120). Note that the filter calculation unit 14 determines the optimum frequency width α and coefficient β on the basis of any of the following methods. Note that the following methods differ in whether determining the frequency width α first or determining the coefficient β first. The first method and the second method described below are examples, and other methods may be used as long as the optimum frequency width α and coefficient β can be determined.

### (First Method)

First, the filter calculation unit 14 fixes the coefficient β (for example, β=1), and determines the frequency width α to be compensated for achieving the optimum signal quality.

Subsequently, the filter calculation unit 14 fixes the determined frequency width α and changes the coefficient β to determine the coefficient β with the optimum signal quality.

### (Second Method)

First, the filter calculation unit 14 fixes the frequency width α (for example, α=100%) and determines the coefficient β with the optimum signal quality. Subsequently, the filter calculation unit 14 fixes the coefficient β and changes the frequency width α to determine the frequency width a with the optimum signal quality.

In the first method and the second method, the criterion for determining the optimum frequency width α may be any one of the following (Determination Criterion 1) to (Determination Criterion 3). Note that the same determination may be made for the coefficient β. The following (Determination Criterion 1), (Determination Criterion 2), and (Determination Criterion 3) are examples, and other criteria may be set as criteria for determining the optimum frequency width α and coefficient β.

(Determination Criterion 1): A signal quality value to be satisfied is determined in advance, and a frequency width α when a value close to the signal quality value (a difference from the signal quality value to be satisfied is less than a threshold) is obtained is determined to be the optimum frequency width α.

(Determination Criterion 2): Candidate values to be set as the frequency width α are determined in advance, signal quality is measured for the candidate values, and the frequency width a having the maximum signal quality is determined as the optimum frequency width α.

(Determination Criterion 3): An initial value, a maximum value, and a minimum value of a are determined in advance, and from the initial value, the value of α is increased (or decreased) as the amount of the frequency width α to be changed, and the optimum signal quality is searched for, and the frequency width α at the optimum signal quality is determined to be the optimum frequency width α. Note that, in a case where a highly accurate signal is required, or the like, the amount of change in the frequency width α is set to a small value and finely adjusted. For example, when it is desired to reduce the calculation load, the change amount of the frequency width α is set to a large value and roughly adjusted, and the optimum α is found.

Hereinafter, a flow of processing for determining the frequency width α and the coefficient β to be the optimum will be described.

### (Case of Determining Optimum Frequency Width a and Coefficient β in (Determination Criterion 1) in First Method)

The filter calculation unit 14 generates a filter by fixing the coefficient β and changing (for example, increase) the frequency width α to be compensated. The filter calculation unit 14 associates and holds the quality information obtained by setting the generated filter in the equalization unit 11 and the values of the frequency widths a to be compensated and β, which are parameters of the filter shape when the quality information is obtained. The filter calculation unit 14 compares the obtained value indicated by the quality information with a predetermined signal quality value, and determines whether or not a difference between the value indicated by the quality information and the predetermined signal quality value is less than a threshold.

When the difference between the value indicated by the quality information and the predetermined signal quality value is less than the threshold, the filter calculation unit 14 determines the frequency width α when the quality information is obtained as the optimum frequency width α. On the other hand, when the difference between the value indicated by the quality information and the predetermined signal quality value is equal to or larger than the threshold, the filter calculation unit 14 changes (for example, increase) the frequency width α to be compensated, and generates the filter again. By repeating such processing, the filter calculation unit 14 determines the frequency width α in which the difference between the value indicated by the quality information and the predetermined signal quality value is less than the threshold.

To determine the optimum coefficient β, the filter calculation unit 14 fixes the determined frequency width α (the frequency width α to be compensated for the optimum) and changes (for example, increase) the coefficient β to generate a filter. The subsequent processing is similar to the flow for determining the optimum frequency width α to be compensated.

### (Case of Determining Optimum Frequency Width α and Coefficient β in (Determination Criterion 2) in First Method)

The filter calculation unit 14 generates a filter by fixing the coefficient β and changing (for example, increase) the frequency width α to be compensated. At this time, the filter calculation unit 14 selects one candidate value from among the candidate values (for example, 70%, 78%, 86%, and the like) set as the frequency width α. The filter calculation unit 14 associates and holds the quality information obtained by setting the generated filter in the equalization unit 11 and the values of the frequency widths a to be compensated and β, which are parameters of the filter shape when the quality information is obtained. Next, the filter calculation unit 14 selects an unselected candidate value from among the candidate values of the frequency width α, fixes the coefficient β, and generates a filter. The filter calculation unit 14 associates and holds the quality information obtained by setting the generated filter in the equalization unit 11 and the values of the frequency widths a to be compensated and β, which are parameters of the filter shape when the quality information is obtained.

The filter calculation unit 14 acquires the quality information for each candidate value of the frequency width α by performing such processing. The filter calculation unit 14 selects the quality information with the best quality from the acquired quality information for each candidate value of the frequency width α. The filter calculation unit 14 determines the frequency width α associated with the selected quality information with the optimum quality as the optimum frequency width α.

To determine the optimum coefficient β, the filter calculation unit 14 fixes the determined frequency width α (the frequency width α to be compensated for the optimum) and changes (for example, increase) the coefficient β to generate a filter. At this time, the filter calculation unit 14 selects one candidate value from among the candidate values (for example, 0.1, 0.5, 1, and the like) set as the coefficient β. The subsequent processing is similar to the flow for determining the optimum frequency width α to be compensated.

### (Case of Determining Optimum Frequency Width α and Coefficient β in (Determination Criterion 3) in First Method)

The initial value, the maximum value, the minimum value, and the amount of change of the frequency width α to be compensated and the initial value, the maximum value, the minimum value, and the amount of change of the coefficient β are determined in advance, and these pieces of information are stored in the filter calculation unit 14. The filter calculation unit 14 fixes the coefficient β and generates a filter with an initial value of the frequency width α. The filter calculation unit 14 associates and holds the quality information obtained by setting the generated filter in the equalization unit 11 and the values of the frequency width α (for example, an initial value) to be compensated and β, which are parameters of the filter shape when the quality information is obtained.

Next, the filter calculation unit 14 changes (for example, increases or decreases) the frequency width α from the initial value by the amount of change, fixes the coefficient β, and generates a filter. Note that the filter calculation unit 14 determines the frequency width α so that the value of the changed frequency width α does not fall below the minimum value or exceed the maximum value. The filter calculation unit 14 associates and holds the quality information obtained by setting the generated filter in the equalization unit 11 and the values of the frequency widths α to be compensated and β, which are parameters of the filter shape when the quality information is obtained.

The filter calculation unit 14 acquires the quality information in each of the plurality of frequency widths α by performing such processing for a predetermined number of times or all the changed frequency widths α based on the change amount. The filter calculation unit 14 selects the quality information with the best quality from the acquired quality information in each of the plurality of frequency widths α. The filter calculation unit 14 determines the frequency width α associated with the selected quality information with the optimum quality as the optimum frequency width α.

In a case where the coefficient β to be the optimum is determined, the filter calculation unit 14 fixes the determined frequency width α (the frequency width α to be compensated to be the optimum) and generates a filter with the initial value of the coefficient. The subsequent processing is similar to the flow for determining the optimum frequency width α to be compensated.

When the optimum frequency width α and the optimum coefficient β are reached, the filter calculation unit 14 sets the filter obtained by the optimum frequency width α and the optimum coefficient β in the equalization unit 11 (step S121).

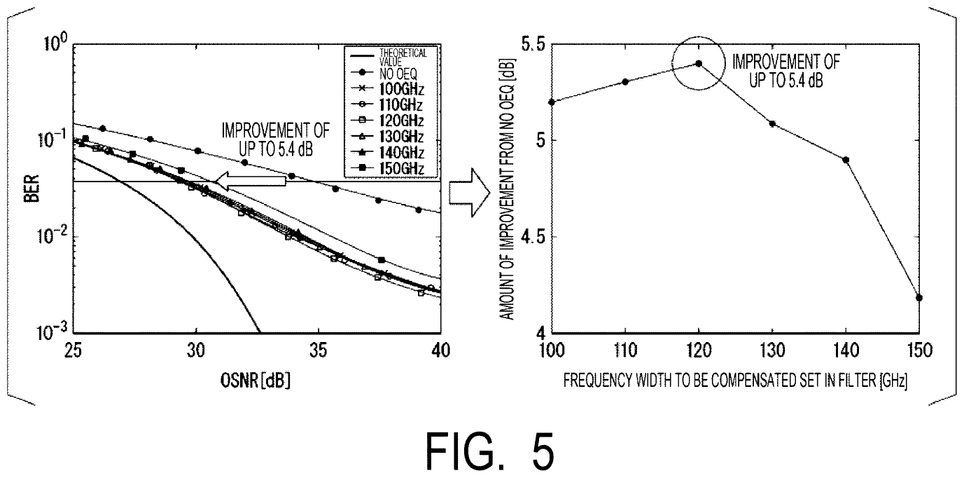

FIG. 5 is a diagram for describing an effect in the first embodiment. The results shown in FIG. 5 are obtained under the following conditions.
Experiment with 128 GBd, 64 QAM signal
The filter setting width was changed to no filter setting (0%), 90 GHz (70%), 100 GHz (78%), 110 GHz (86%), 120 GHz (94%), 130 GHz (101%), 140 GHz (109%), and 150 GHz (117%)

As a result, as illustrated in the left diagram of FIG. 5, it was possible to confirm the effect of improving the Optical SNR (OSNR) yield strength of 5.4 dB at the maximum without filter setting. The frequency width α to be compensated when an OSNR improvement of up to 5.4 dB was observed was 94% (120 GHz) as shown in the right diagram of FIG. 5.

According to the optical transmission system 100 configured as described above, it is possible to improve the compensation accuracy as compared with the related art. Specifically, the optical transmission system 100 includes an optical transmitter 10 that transmits an optical signal, an equalization unit 11 that equalizes the optical signal transmitted from the optical transmitter 10 in the optical domain, an optical receiver 12 that receives the optical signal equalized by the equalization unit 11 and acquires quality information regarding the quality of the received optical signal, and a filter calculation unit 14 that generates a filter to be used for equalization processing on the basis of spectrum information and quality information of the optical signal equalized by the equalization unit 11 and sets the filter in the equalization unit 11. As a result, the filter shape of the equalization unit 11 that maximizes the received signal quality can be determined according to the characteristics of the optical amplifier, the modulation scheme, the transmission distance, and the transmission capacitance, and can be applied to the equalization unit 11. Therefore, compensation accuracy can be improved as compared with the related art, and high-quality optical transmission can be realized.

### Second Embodiment

In a second embodiment, a configuration in a case where the optical transmission system 100 does not include an OPA will be described.

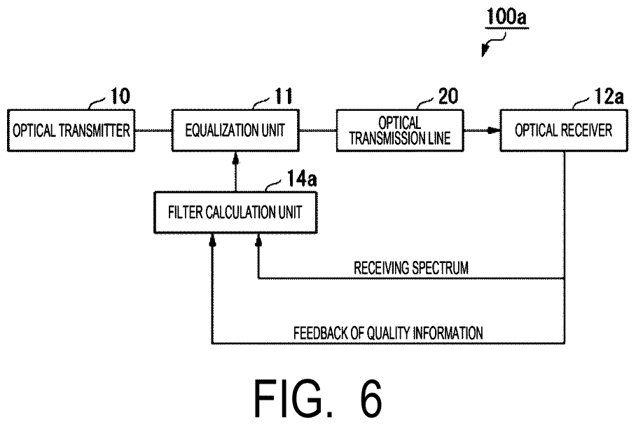

FIG. 6 is a diagram illustrating a configuration example of an optical transmission system 100a according to the second embodiment. The optical transmission system 100a includes an optical transmitter 10, an equalization unit 11, an optical receiver 12a, and a filter calculation unit 14a. The optical transmitter 10 and the optical receiver 12a are connected via an optical transmission line 20. The optical transmission system 100a is different from the optical transmission system 100 in that the OSA 13 is not provided. Other configurations of the optical transmission system 100a are similar to those of the optical transmission system 100. Hereinafter, differences from the optical transmission system 100 will be described.

The optical receiver 12a receives the optical signal subjected to the equalization processing by the equalization unit 11. The optical receiver 12 acquires quality information of the received optical signal. Further, the optical receiver 12a acquires a signal spectrum of the received optical signal. The optical receiver 12a feeds back the acquired quality information and spectrum information to the filter calculation unit 14a.

The filter calculation unit 14a calculates a filter to be set in the equalization unit 11 on the basis of the quality information and the spectrum information output from the optical receiver 12. The filter calculation unit 14a sets the calculated filter in the equalization unit 11.

The specific processing in the optical transmission system 100a is different from the processing in the optical transmission system 100 in that the signal spectrum is acquired by the optical receiver 12a, and the optical receiver 12a outputs the quality information and the spectrum information to the filter calculation unit 14a.

According to the optical transmission system 100a configured as described above, since the OSA 13 is not provided, a similar effect can be realized with an inexpensive configuration as compared with the optical transmission system 100.

### Third Embodiment

In a third embodiment, only the equalization processing in the optical domain is performed in the first embodiment and the second embodiment. In the third embodiment, a configuration for performing equalization processing in an electrical domain and an optical domain will be described.

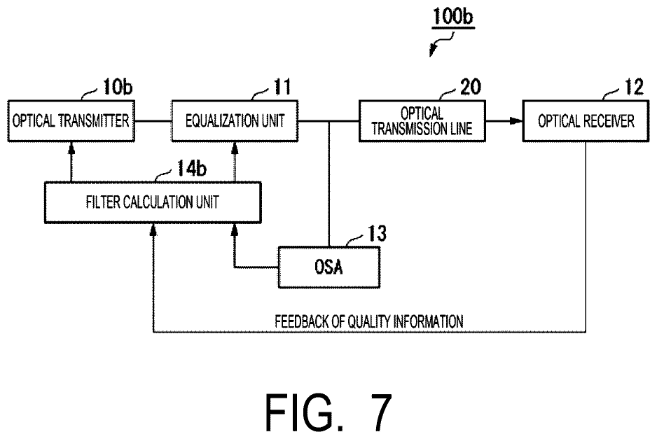

FIG. 7 is a diagram illustrating a configuration example of an optical transmission system 100b in the third embodiment. The optical transmission system 100b includes an optical transmitter 10b, an equalization unit 11, an optical receiver 12, an OSA 13, and a filter calculation unit 14b. The optical transmitter 10b and the optical receiver 12 are connected via an optical transmission line 20. The optical transmission system 100b is different from the optical transmission system 100 in that equalization is performed even in an electrical domain in the optical transmitter 10b. Other configurations of the optical transmission system 100b are similar to those of the optical transmission system 100. Hereinafter, differences from the optical transmission system 100 will be described.

The optical transmitter 10b transmits an optical signal. For example, the optical transmitter 10b transmits a polarization multiplexed signal. Note that the optical transmitter 10b may transmit an optical signal subjected to wavelength multiplexing or spatial multiplexing in addition to polarization multiplexing. Furthermore, the optical transmitter 10b performs equalization processing of a signal in the electrical domain on the basis of the filter set by the filter calculation unit 14b.

The filter calculation unit 14b calculates a filter to be set in the optical transmitter 10b and the equalization unit 11 on the basis of the quality information output from the optical receiver 12 and the spectrum information output from the OSA 13. The filter calculation unit 14 sets the calculated filter in the optical transmitter 10b and the equalization unit 11.

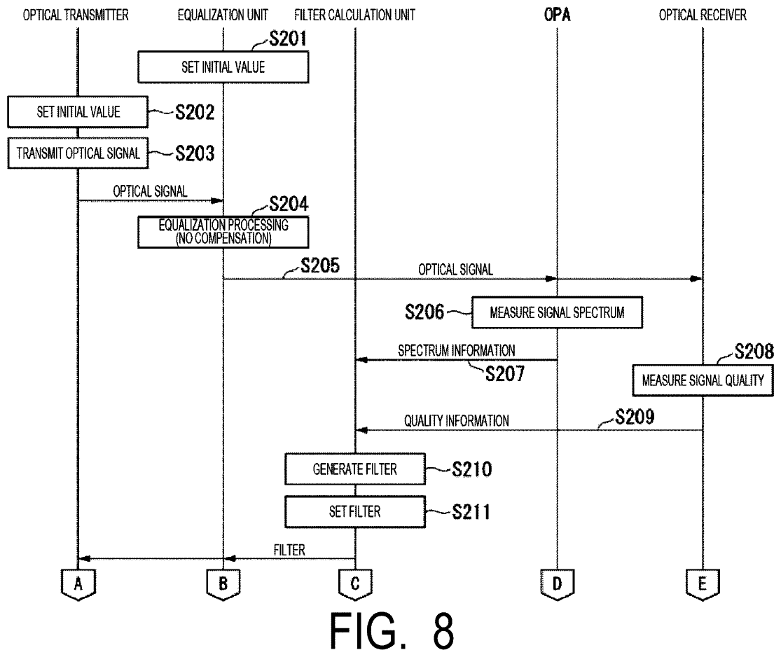

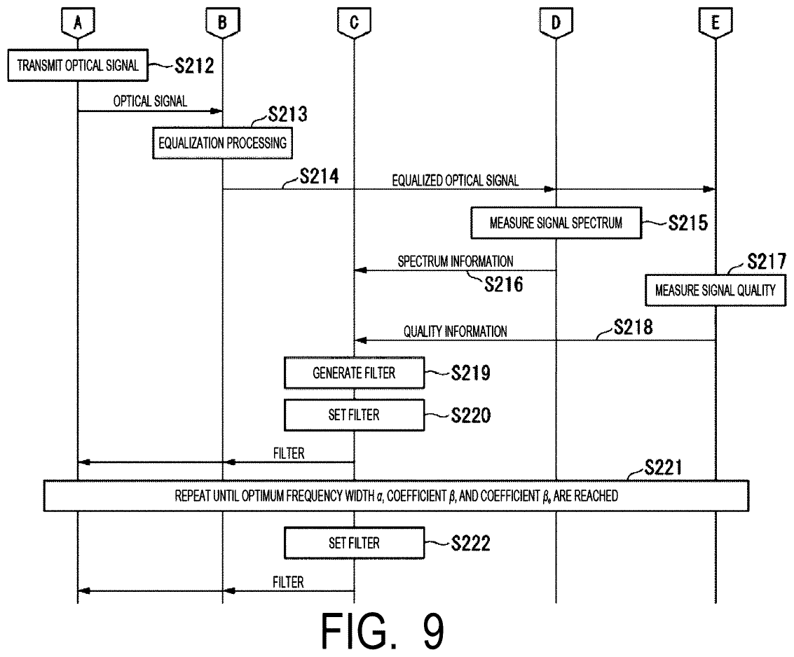

FIGS. 8 and 9 are sequence diagrams illustrating a flow of processing of the optical transmission system 100b in the third embodiment.

The equalization unit 11 sets an initial value at the start of processing (step S201). Here, as the initial value, no compensation by the filter (a frequency width α to be compensated=0%) is set in the equalization unit 11. At the start of the process, the optical transmitter 10 sets an initial value for performing the equalization processing in the electrical domain (step S202). Here, as an initial value, no compensation by the filter is set to the optical transmitter 10b.

Thereafter, the optical transmitter 10 transmits the optical signal without performing equalization processing in the electrical domain (step S203). The optical signal transmitted by the optical transmitter 10 is input to the equalization unit 11 via the optical transmission line.

The equalization unit 11 performs equalization processing on the input optical signal (step S204). Since no compensation by the filter (a frequency width α to be compensated=0%) is set as the initial value, the optical signal input to the equalization unit 11 is output without being compensated (step S205). The optical signal output from the equalization unit 11 is branched in the optical transmission line 20. The branched optical signal is received by the optical receiver 12 and the OSA 13.

The OSA 13 measures a signal spectrum of the received optical signal (step S206). The OSA 13 outputs spectrum information obtained by the measurement to the filter calculation unit 14b (step S207). As a result, spectrum information is input to the filter calculation unit 14b. The optical receiver 12 measures the signal quality of the received optical signal (step S208). The optical receiver 12 outputs the information on the signal quality obtained by the measurement to the filter calculation unit 14b as quality information (step S209). As a result, the quality information is input to the filter calculation unit 14b.

The filter calculation unit 14b generates a filter based on the input spectrum information and quality information (step S210). Specifically, the filter calculation unit 14b generates a filter using the inverse characteristic H^{-β}(f) (0≤β) of the frequency width (for example, α=10%) to be compensated on the basis of the amplitude characteristic H(f) of the input signal spectrum. For example, when β=1, it is assumed that the signal spectrum after compensation approaches flat. From here, the filter calculation unit 14b determines the coefficient βₑ as an index for determining the inverse characteristic in the electrical domain equalization and the coefficient βₒ as an index for determining the inverse characteristic in the optical domain equalization so as to satisfy β=β_{c}+βₒ(H^{-β}(f)=H^{-βe}(f)×H^{-βo}(f)). For example, the filter calculation unit 14b determines βₑ=0.1β and βₒ=β−βₑ=0.9β. The filter calculation unit 14b sets the generated filter in the optical transmitter 10b and the equalization unit 11 (step S211).

The optical transmitter 10b generates an optical signal after performing equalization processing on the electrical signal with the filter set by the filter calculation unit 14b. The optical transmitter 10b transmits the generated optical signal (step S212). The optical signal transmitted by the optical transmitter 10 is input to the equalization unit 11 via the optical transmission line. The equalization unit 11 performs equalization processing on the input optical signal (step S213). At this time, since a filter is set (a frequency width α to be compensated=10%) in the equalization unit 11, equalization processing is performed on the optical signal input to the equalization unit 11. As a result, the optical signal is compensated. The equalization unit 11 outputs the equalized optical signal to the optical transmission line 20 (step S214). The optical signal output from the equalization unit 11 is branched in the optical transmission line 20. The branched optical signal is received by the optical receiver 12 and the OSA 13.

The OSA 13 measures a signal spectrum of the received optical signal (step S215). The OSA 13 outputs spectrum information obtained by the measurement to the filter calculation unit 14b (step S216). As a result, spectrum information is input to the filter calculation unit 14b. The optical receiver 12 measures the signal quality of the received optical signal (step S217). The optical receiver 12 outputs the information on the signal quality obtained by the measurement to the filter calculation unit 14b as quality information (step S218). As a result, the quality information is input to the filter calculation unit 14b.

The filter calculation unit 14b generates a filter based on the input spectrum information and quality information (step S219). Specifically, the filter calculation unit 14b generates a filter by increasing the frequency width α, the coefficient β, and the coefficient βₑ to be compensated on the basis of the amplitude characteristic H(f) of the input signal spectrum. Note that the filter calculation unit 14b may increase βₒ instead of the coefficient β_{c}. The filter calculation unit 14b sets the filter generated again in the optical transmitter 10b and the equalization unit 11 (step S220).

Thereafter, the processing from step S212 to step S220 is repeatedly executed until the optimum frequency width α, coefficient β, and coefficient βₑ=β (In the case of increasing βₒ, βₒ=β) are reached (step S221). The method of determining the optimum frequency width α and the coefficient β is similar to that in the first embodiment. When the optimum frequency width α, the coefficient β, and the coefficient βₑ=β are reached, the filter calculation unit 14b sets the filter obtained by the optimum frequency width α, the coefficient β, and the coefficient βₑ=β in the optical transmitter 10b and the equalization unit 11 (step S222).

According to the optical transmission system 100b configured as described above, the equalization processing is performed not only in the optical domain but also in the electrical domain. As a result, in the digital equalization, fine adjustment can be performed as compared with the equalization processing of the optical domain, so that higher signal quality can be obtained.

### Modification Example of Third Embodiment

The optical transmission system 100b may not include the OSA 13. With such a configuration, the optical receiver 12 acquires the signal spectrum of the optical signal in addition to the quality information of the optical signal as in the optical receiver 12a in the second embodiment. The optical receiver 12 feeds back the acquired quality information and spectrum information to the filter calculation unit 14b. and 12a or the filter calculation units 14, 14a, and 14b in the above-described embodiments may be implemented by a computer. In that case, a program for implementing the functions may be recorded in a computer-readable recording medium, and the functions may be implemented by loading the program recorded in this recording medium to a computer system, and executing the program. Note that, the “computer system” referred to herein includes an OS and hardware such as peripheral equipment.

The “computer-readable recording medium” refers to a portable medium such as a flexible disk, a magneto-optical disk, a read only memory (ROM), or a CD-ROM, or a storage device such as a hard disk included in a computer system, for example. Moreover, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. The above-described program may be for implementing some of the functions described above, may be implemented by a combination of the functions described above and a program already recorded in a computer system, or may be implemented with a programmable logic device such as a field-programmable gate array (FPGA).

Although the embodiments of the present invention have been described in detail with reference to the drawings, the specific configuration is not limited to the embodiments, and includes design and the like without departing from the spirit of the present invention.

### INDUSTRIAL APPLICABILITY

The present invention can be applied to equalization technology in digital coherent optical transmission.

### REFERENCE SIGNS LIST

10, 10b Optical transmitter
11 Equalization unit
12, 12a Optical receiver
13 OSA
14, 14a, 14b Filter calculation unit
20 Optical transmission line
100, 100a, 100b Optical transmission system

1. An optical transmission system comprising:
an optical transmitter configured to transmit an optical signal;
an equalizer configured to equalize the optical signal transmitted from the optical transmitter in an optical domain;
an optical receiver configured to receive the optical signal equalized by the equalizer and acquires quality information regarding quality of the received optical signal; and
a filter generator configured to generate a filter to be used for equalization processing on the basis of spectrum information of the optical signal equalized by the equalizer and the quality information and sets the filter in the equalizer.

2. The optical transmission system according to claim 1, further comprising
a spectrum information acquirer configured to acquire spectrum information of the optical signal equalized by the equalizer,
wherein the filter generator generates a filter to be used for equalization processing on the basis of the spectrum information of the optical signal acquired by the spectrum information acquirer and the quality information and sets the filter in the equalizer.

3. The optical transmission system according to claim 1, wherein
the optical receiver further acquires spectrum information of the optical signal equalized by the equalizer, and
the filter generator generates a filter to be used for equalization processing on the basis of the spectrum information of the optical signal acquired by the optical receiver and the quality information and sets the filter in the equalizer.

4. The optical transmission system according to claim 1, wherein
the filter generator generates the filter including a frequency width to be compensated and a coefficient for achieving an optimum signal quality and sets the filter in the equalizer.

5. The optical transmission system according to claim 1, wherein
the filter generator generates the filter including a coefficient for performing an equalization processing in an electrical domain in the optical transmitter and including a coefficient for performing an equalization processing in an optical domain in the equalizer, and sets the filter in the optical transmitter and the equalizer unit.

6. An equalization method comprising:
transmitting, by an optical transmitter, an optical signal;
equalizing, by an equalizer, the transmitted optical signal in an optical domain;
receiving, by an optical receiver, the equalized optical signal and acquiring quality information regarding quality of the received optical signal; and
generating, by a filter generator, a filter to be used for equalization processing on the basis of spectrum information of the equalized optical signal and the quality information and setting the filter in the equalizer.
